(19) United States
(12) Patent Application Publication
(10) Pub. No.: US 2004/0232597 A1
(43) Pub. Date: Nov. 25, 2004

(54) Method for sealing an access channel of an implantable medical device

(75) Inventors: Johan Sjostedt, Stockholm (SE); Per Jarl, Jarfalla (SE)

Correspondence Address: SCHIFF HARDIN, LLP, PATENT DEPARTMENT, 6600 SEARS TOWER, CHICAGO, IL, 60606-6473, US

(73) Assignee: St. Jude Medical AB

(21) Appl. No.: 10/842,677

(22) Filed: May 10, 2004

(30) Foreign Application Priority Data
May 22, 2003 (SE) 0301506-2

(51) Int. Cl. B28B 3/06

(52) U.S. Cl. 264/297.2; 264/318

(57) ABSTRACT

In a method for sealing an access channel provided for permitting a tool to access a setscrew for securing an electronic lead connector pin to a connector block in the header of a pacemaker or the like, a sealing device having a flexible body with at least one open through hole is formed in a one-step operation. The sealing device has a cross dimension that at least in one direction is larger than a corresponding cross dimension of the access channel. The sealing device is mounted in the header by compressing and positioning the sealing device in the access channel. The difference in cross dimension between the access channel and the sealing device is such that a maintained deformation of the sealing device occurs, which produces a sealing closure of the through hole(s) when the sealing device is mounted in the access channel.

### BACKGROUND OF THE INVENTION

1. Field of the Invention

The present invention generally relates to the field of implantable medical devices utilizing pulse generators to stimulate selected body tissue. More specifically, the invention relates to a method for sealing an access channel in such an implantable medical device.

2. Description of the Prior Art

Present day cardiac pacemakers are typically designed to be implanted in a “pocket” of fatty tissue near the patient's upper chest or lower abdomen. Accordingly, electronic circuits within the pacemaker are hermetically sealed within a housing made of a material that is compatible with body tissue. Electrical connection with the pacemaker electronic circuits in the housing is accomplished via feedthrough terminals that pass through the hermetically sealed housing via a connector assembly, often referred to as a header or header assembly, that is mounted to the pacemaker housing. The feedthrough terminals are electrically connected to a connector receptacle in the connector assembly for receiving a connector pin at the proximal end of a pacing lead. The lead has a distal end provided with electrodes for positioning and attachment at the desired tissue location.

Good electrical contact must be maintained between the connector pin at the proximal end of the pacing lead and the pacing lead receptacle of the pacemaker. Furthermore, the connection must be mechanically secure so that it does not come apart during use, yet it must be detachable in the event the pacemaker or lead needs to be replaced. Moreover, the connection at all times should remain insulated and sealed from body fluids since such fluids are conductive and could cause short-circuiting if permitted to enter the connector assembly.

After positioning of the distal end of the pacing lead in cardiac tissue, the connector pin at the proximal end of the pacing lead is connected to the pacemaker by inserting the connector pin into the pacing lead, or connector pin, receptacle. Use of the correct connector pin (or connector pin adapter) assures that the connector pin makes a tight fit in the receptacle.

The connector pin is secured within the connector pin receptacle by means of a setscrew received in a threaded opening in the connector assembly. Good electrical contact between the pin and receptacle is also thereby assured. The setscrew is accessed with a manipulating tool via an access channel provided in the connector assembly. The access channel thus provides access from the outside of the pacemaker to the threaded opening and the setscrew positioned therein.

Generally in the case of prior art devices, an insulating plug of rubber or the like is provided in the access channel in order to prevent body fluids from entering the access channel, and to seal the setscrew and the threaded opening from the surrounding body fluids. The plug has a normally sealed passage that may be forced open by the distal end of a setscrew manipulating tool, such as a hexagon wrench or the like, to allow it to pass through the passage and access the setscrew. The prior art plug is further self-sealing, so that upon retraction of the tool from the passage, the passage is closed and continued insulation of the access channel and the setscrew is provided.

U.S. Pat. No. 5,509,928 illustrates one example of such an access plug. Following molding of the plug to a desired shape, and in order to form an access plug provided with a self-sealing passage for permitting the end of a manipulating tool to be passed through the plug, the passage is produced by cutting a slit along the center of the plug following molding of the plug, this slit extending through the entire plug. Then, the intrinsic forces in the plug will push or force the surfaces of the slit together such that a sealing function is obtained when the plug is mounted in the header assembly. In order not to impair the sealing properties of the plug, it is important that any punching of the plug is avoided when the passage is produced. In other words, the process of cutting the slit has to be performed without any material being removed from the plug. The process of providing the plug with such a slit is thus a very delicate process that becomes even more difficult due to the very small dimensions of the access plug. The fact that the access plug preferably is made of a very flexible material, for enhancing the self-sealing properties of the plug, renders the process of providing this slit, extending through the entire plug, even more difficult.

U.S. Pat. No. 4,932,409 discloses another example of a self-sealing access plug. In this example, the plug is molded into an annular shape, such as a ring or the like. The wall thickness of the ring is greater than the radius of the central opening of the ring. After the molding process, the ring is turned inside out such that its outer edge is turned inward. The flexibility of the ring permits the distal end of a manipulating tool to pass through the ring. Due to the size relationship between the wall thickness and the ring opening, the broad outer surface of the ring is compressed with sufficient pressure so that the seal element is hermetically closed after retraction of a manipulating tool. Due to the small dimensions of the access plug, the turning of the access plug inside out is a delicate operation, which has to be performed following sufficient curing of the plug after molding.

Thus, both of these prior art self-sealing plugs require additional process steps to be carried out, following the molding and curing thereof, before arriving at a plug ready for mounting or assembly in an implantable medical device, such as a pacemaker.

### SUMMARY OF THE INVENTION

An object of the present invention is to provide an improved method for sealing an access channel in an implantable medical device.

This and other objects are achieved according to the present invention by a method for sealing an access channel in an implantable medical device using a sealing device, formed by a flexible body with an open through hole, the body having a cross dimension that is at least in one direction greater than the corresponding cross dimension of the access channel. Upon mounting of the sealing device in the access channel, the difference in the cross dimensions brings about a deformation of the sealing device when mounted in the access channel that closes the through hole and seals the access channel.

The terms cross dimension and cross-section as used herein refer to a plane essentially perpendicular to the inserting direction when mounting the plug in the access channel in the header of the medical implant.

When the distal end of a tool, such as a manipulating tool, is forced against the closed through hole in the plug mounted in the access channel, the flexible body of the plug yields slightly outwardly, i.e. toward the walls of the access channel, such that the hole in the plug opens and the end of the tool can be passed through the seal. Upon retraction of the tool from the access channel and the plug, the flexible body of the plug resumes its previous shape and the through hole closes and seals from the external forces of the interior walls of the access channel.

Thus, in accordance with the present invention, since the self-sealing ability of the sealing device is provided by the interaction of the flexible sealing device with the access channel, there is no need for the sealing device itself to have self-sealing properties. Therefore, the sealing device may be produced in a one step operation in which the sealing plug with the through hole therein is formed. This is in contrast to the prior art access plugs that not only require additional manufacturing steps to be carried out, but most likely also require additional machinery of varied complexity. Thus, the present invention provides a method for sealing an access channel that will reduce manufacturing complexity, time and costs as compared to the methods for sealing an access channel known in the art.

A significant advantage of using a plug that does not in itself have self-sealing capabilities is that the opposing surfaces of the through hole are not in contact before the plug is mounted in the medical implant. Thus, the opposing surfaces cannot net together, which could cause a punching of the plug when attempting to force a tool there through. Furthermore, due to the correspondence in their surface structures, surfaces that have been separated by cutting are more likely to net together compared to surfaces that are initially formed as separate surfaces. Therefore, in contrast to the prior art self-sealing plug with a cut slit, there is no risk that the opposing surfaces of the through hole will net together prior to mounting of the plug in the medical implant, and there is a reduced risk of netting when the plug is in its mounted state. Thus, in accordance with the present invention, the risk of punching out a portion of the plug when passing a manipulating tool through the plug, both during implantation and at a later stage, is greatly reduced.

Additionally, when the end of a tool is forced through the plug, the walls of the plug are compressed or deformed radially or transversely, i.e. essentially perpendicular to the insertion direction of the tool. Thus, there will be little or no deformation of the plug in the insertion direction. In the prior art plugs, however, the portion of the plug adjacent to the passage is partly deformed longitudinally, i.e. in the insertion direction of the tool, cf. FIGS. 3 and 5 of the U.S. Pat. No. 5,509,928 patent. Therefore, since there is no substantial longitudinal deformation of the plug during insertion of a tool, there is also no need to provide deformation space in the plug or between the plug and the underlying setscrew. Thus, the plug or the distance between the plug and the surface of the header can be made smaller which, in turn, makes possible a reduction in size for the medical implant.

Preferably, the sealing device, hereinafter referred to as the plug, is formed in a one step operation in which the through hole and the flexible body surrounding the hole are directly formed. In one embodiment, the plug is formed by injection molding using a mold that is arranged to produce the flexible body with the through hole. Thus, the through hole of the plug is in effect injection molded and no additional process steps are required to provide the plug with the through hole.

In preferred embodiments of the invention, the plug is provided with one through hole for sealing but still permitting access to one setscrew, or the like. In other embodiments of the invention, the plug is provided with a number of through holes for sealing and permitting access to a number of setscrews. Then, the plug, i.e. its flexible body and the number of through holes, and the access channel are dimensioned such that the walls of the access channel compress the plug such that all through holes close and seal their respective access channels. Thus, in a medical implant where two or more leads have to be securely connected to the implant, it would be sufficient to manufacture and mount only one plug. This entails a reduction in manufacturing and assembly time and costs as compared to a solution with one plug for each access channel and setscrew.

In preferred embodiments of the invention, the through hole has an elongated cross-section, although other shapes are within the scope of the present invention. Preferably, the difference in the cross dimension between the access channel and the plug is essentially in a direction transverse of the elongation of the through hole. Thus, upon mounting of the plug in the access channel, the plug is mainly compressed or deformed in the direction transverse to the elongation of the hole. Thereby, the most adjacent of the facing interior surfaces of the through hole are brought into contact and the sealing of the access channel is produced.

In embodiments of the present invention, the sealing device or plug has an elongated cross-section, for instance essentially rectangular or elliptical. Other cross-sections of the plug of the present invention can be used without departing from the scope of the present invention.

Preferably, the plug is formed of silicone or a thermoplastic elastomer, any suitable material having desired flexibility and tissue compatibility properties can be used.

### DESCRIPTION OF THE DRAWINGS

FIG. 1 is a side elevation view, partly in section, of the header assembly of a typical, prior art unipolar cardiac pacemaker showing a connector pin setscrew and a prior art sealing plug over the setscrew.

FIG. 2 is a side elevation view, in cross-section, of a portion of the header assembly of a cardiac pacemaker showing a self-sealing septum in accordance with the prior art.

FIGS. 3a-3c are schematic side elevation views of casting molds for use in the method according to the present invention.

FIGS. 4a-4c are schematic plan elevation views of the casting molds shown in FIGS. 3a-3c, respectively.

FIGS. 5a-5c are schematic plan elevation views showing examples of septum plugs for use in the method of the present invention and produced with the casting molds shown in FIGS. 3a-3c and 4a-4c.

FIG. 6a is a plan elevation view of a casting mold for use in an alternative embodiment of the present invention, and FIG. 6b is plan elevation view of a septum plug produced with the casting mold shown in FIG. 6a.

FIGS. 7a and 7b are schematic plan elevation views of the septum plugs of FIGS. 5a and 5b, respectively, and of the portion of the header assemblies containing the access channel, illustrating the interaction of the septum plug and header assembly in the method in accordance with the present invention.

### DESCRIPTION OF THE PREFERRED EMBODIMENTS

Those skilled in the art will readily realize that the present invention is applicable to a variety of implantable medical devices utilizing pulse generators to stimulate selected body tissue. The invention and its background will be described herein, however, in terms of a specific example of such implantable devices, namely cardiac pacemakers for providing stimulation pulses to the heart.

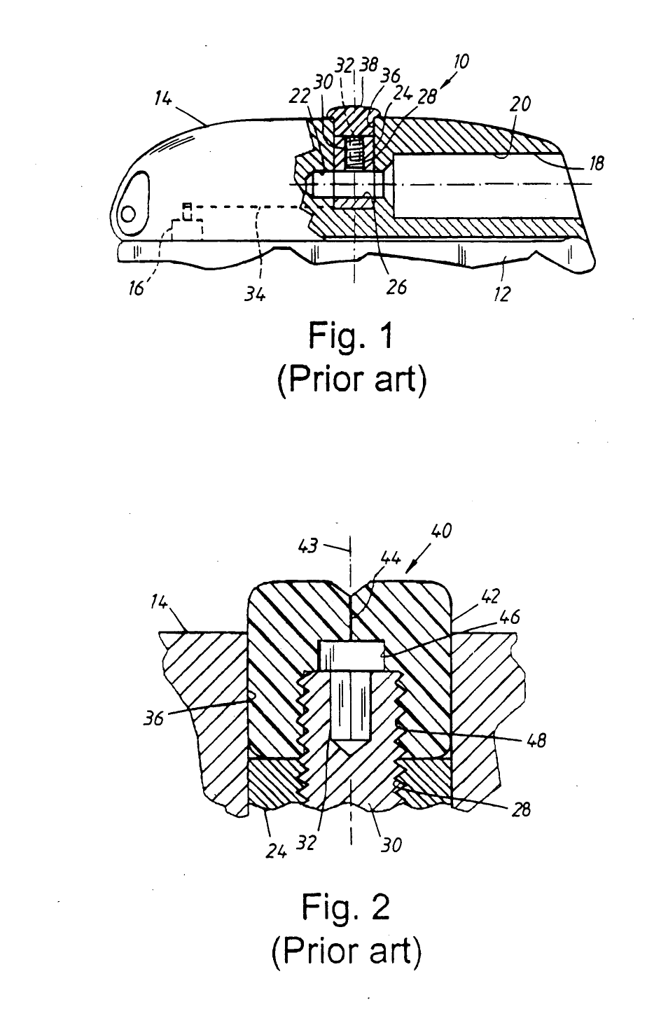

Referring first to FIGS. 1 and 2, there is shown the general principle of sealing an access channel in an implantable medical device, such as a cardiac pacemaker.

FIG. 1 shows a portion of a prior art unipolar cardiac pacemaker 10 that includes a hermetically sealed housing 12 enclosing the pacemaker electronic circuits and battery. The pacemaker 10 includes a header or connector assembly 14 which may be made of insulative material and which encloses a feedthrough terminal 16 for making electrical contact with the pacemaker electronic circuits within the housing 12. In some pacemaker models, the sealed housing 12—frequently referred to as the pacemaker “can”—is made from an electrically conductive material, and electrical contact may thus also be made through an exposed, non-insulated portion of the conductive material of the “can”.

The header 14 defines a longitudinally extending connector receptacle 18 for receiving a connector pin at the proximal end of a pacing lead (not shown). The receptacle 18 includes a main portion 20 and a smaller diameter portion 22 for receiving the tip electrode of the pacing lead. Molded into the header 14 is a tip connector block 24 made from a conductive material, such as stainless steel, compatible with body fluids. The tip connector block 24 has a longitudinal hole or channel 26 in alignment with and of the same diameter as the tip receiving portion 22 of the receptacle 18. The tip electrode of the pacing lead is received in this channel when the pacing lead connector pin is fully inserted into the receptacle 18. The tip connector block 24 further includes a threaded hole 28 extending perpendicular to the channel 26 for receiving a setscrew 30. The setscrew 30 includes a hex cavity 32 for receiving a hex wrench or key (not shown) for tightening or loosening the setscrew 30, all as well known in the art. Thus, with the tip electrode of the pacing lead in place within the tip receiving portion 22 of the receptacle 18, the setscrew 30 is tightened with a hex key in conventional fashion to firmly secure the tip electrode to the tip connector block 24 both mechanically and electrically. A conductive wire or ribbon 34 connects the tip connector block 24 with the feedthrough terminal 16. The tip connector block 24 is recessed within the header 14 to define a blind hole 36 constituting an access channel providing external access to the setscrew 30. Into the access channel 36 there is inserted a, for example, generally cylindrical insulative sealing plug 38 for isolating the setscrew 30 electrically and protecting it from bodily fluids. In the prior art arrangement illustrated in FIG. 1, it is necessary to remove the plug 38 in order to gain access to the setscrew 30 to tighten or loosen it.

FIG. 2 shows an alternative prior art setscrew isolating plug in the form of a self-sealing septum 40 of silicon rubber, for example, having an outer generally cylindrical surface 42, a central axis 43, and a central, normally sealed passage 44 for receiving a hex key that may be inserted into the hex cavity 32 of the setscrew 30. In the prior art example shown, the septum 40 defines an internal, centrally disposed stepped bore comprising an upper recess or chamber 46 providing clearance for the tip of the hex wrench and a lower recess or chamber 48 having a larger diameter than the upper recess 46 and which provides clearance for the upper end of the setscrew 30.

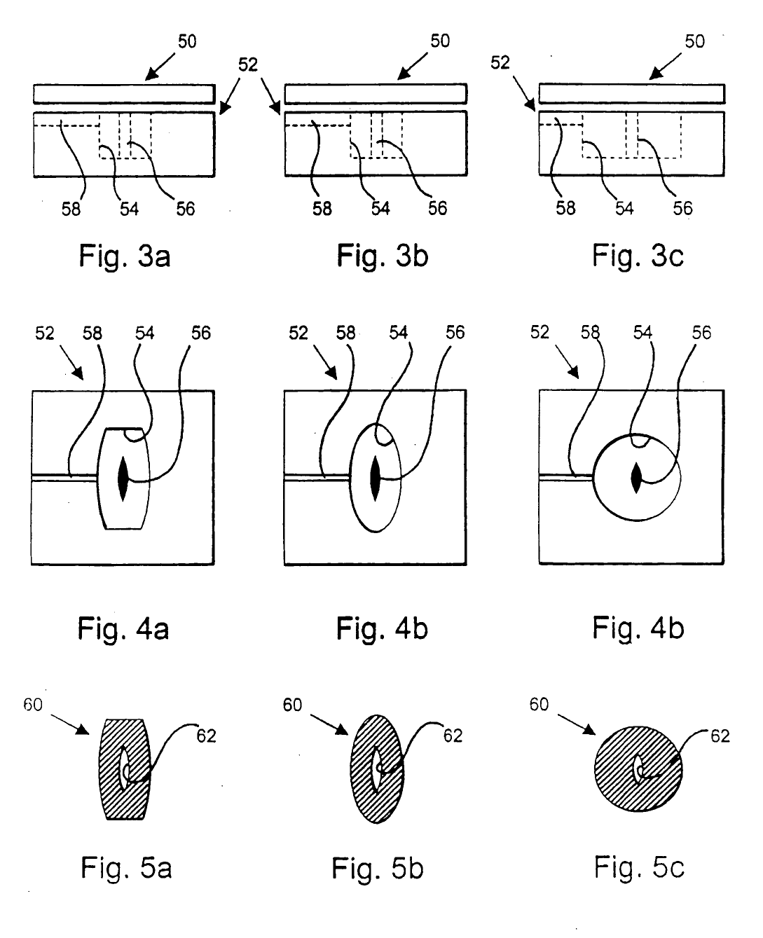

With reference to FIGS. 3-6, embodiments of the present invention will now be described. Turning first to FIGS. 3a-3c and 4a-4c, there are shown three examples of differently shaped casting molds that could be used for producing sealing devices in accordance with the present invention. However, any other suitably shaped casting molds could also be used without departing from the present invention. The casting molds include a first, solid mold part 50 and a second mold part 52. The second mold part 52 has a molding cavity 54 and an injection channel 58 for providing access to the molding cavity 54. In the molding cavity there is provided a mold core 56.

In the molding operation, the two mold parts 50 and 52 are brought together and a cast or molding compound, which preferably is silicone or a thermoplastic elastomer, is injected into the injection channel 58 and pressed into the molding cavity 54. When the molding compound has cured, a septum plug 60 has been formed comprising a through hole 62. FIGS. 5a-5b show three examples of the differently shaped septum plugs 60 produced with the molds of FIGS. 3a-3c and 4a-4c, respectively. For ease of description, only three alternative shapes are shown, but any suitable shape may be used for the septum plugs 60 within the scope of the present invention, as long as a reduction in the cross dimension would produce a sealing closure of the through hole 62.

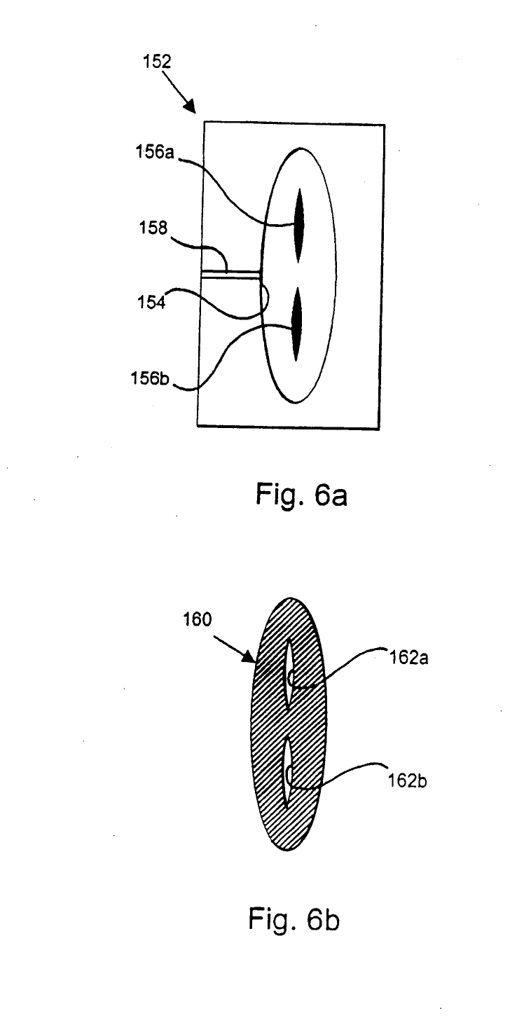

In FIGS. 6a and 6b, there is shown an example of casting mold 152 and a septum plug 160 according to alternative embodiments of the present invention. In this example, the molding cavity 154 of the casting mold 152 is provided with two mold cores 156a, 156b. Thus, the resulting septum plug 160 will have two spaced apart through holes 162a, 162b. Thus, the septum plug 160 is arranged for permitting access via the through holes thereof 162a, 162b for hex keys or the like to two set screws provided at different locations in the header assembly. Consequently, this septum plug example is adapted for medical implants using more than one lead. Although not shown, septum plugs having more than two through holes are also contemplated without departing from the scope of the present invention.

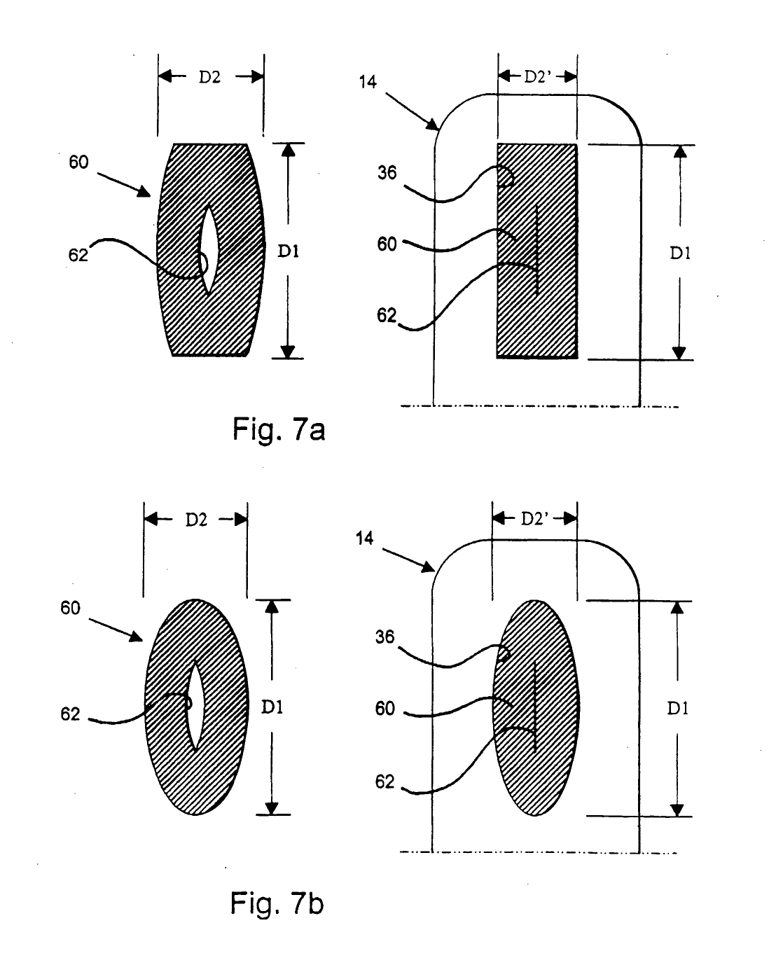

Turning now to FIGS. 7a and 7b, there is shown the septum plugs of FIGS. 5aand 5b, respectively, in an uncompressed state, i.e. in the shape into which they have been molded, and in a compressed state after positioning of the septum plug in the access channel 36 of the header 14. For ease of description, only the portion of the header 14 that contains the access channel 36 is shown. On the left side in each figure, the respective plug 60, having a through hole 62 is shown with a longitudinal cross dimension D1 and a lateral dimension D2.

In these examples, the corresponding cross dimensions of the access channel 36 are referred to as D1 and D2′, where the lateral cross dimension D2′ is smaller than that of the septum plug 60. Thereby, upon lateral compression of the plug 60, i.e. reduction in the lateral dimension of the plug, and positioning thereof in the corresponding access channel 36, the difference in lateral cross dimensions D2 and D2′ will result in a compression of the septum plug 60 that produces a closure of the through hole 62. The closure of the through hole 62 will, thus, provide a sealing closure of the access channel 36 in the header 14 that is maintained as long as the access plug 60 is mounted in the header 14, while simultaneously, due to the resilience of the plug 60, provide access, via the through hole, to the setscrew for a hex key or the like.

In these examples, there is no difference in the longitudinal cross dimension D1 for the plug 60, 160 and the access channel 36. However, any difference in lateral, longitudinal or other suitable cross dimensions are contemplated within the scope of the present invention, provided that it will produce a sealing closure of the through hole(s) 62, 162 when the plug 60, 160 is mounted in the access channel 36 in the header 14.

It is understood by those of ordinary skill in the art that the specific embodiments shown and described herein may be substituted for a variety of alternative and/or equivalent implementations without departing from the scope of the present invention.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for sealing an access channel in an implantable medical device, comprising the steps of:
forming a sealing device in a one-step operation, as a flexible body with at least one through hole, said sealing device having a cross dimension that at least in one direction is larger than a corresponding cross dimension of the access channel; and
mounting said sealing device in said implantable medical device by compressing said sealing device and positioning said sealing device in the access channel, with the difference in cross dimension between the access channel and the sealing device producing and maintaining a deformation of the sealing device, causing a sealed closure of said at least one through hole when the sealing device is mounted in the access channel.

2. The method as claimed in claim 1 comprising in said one-step operation, molding said sealing device using a mold causing said through hole to be produced during said injection molding.

3. The method as claimed in claim 1, comprising forming said through hole with spaced apart opposing interior surfaces, and wherein said deformation brings the interior surfaces of said through hole into contact for producing said sealed closure of said through hole.

4. The method as claimed in claim 1, comprising forming said sealing device of a material selected from the group consisting of silicone and thermoplastic elastomer.

5. The method as claimed in claim 1, wherein said access channel permits a setscrew manipulating tool to access at least one setscrew for securing an electronic lead connector pin to a connector block in said implantable medical device, and comprising forming said at least one through hole in said body for permitting a distal end of said tool to pass through said sealing device.
